(19) United States
(12) Patent Application Publication
(10) Pub. No.: US 2005/0074368 A1
(43) Pub. Date: Apr. 7, 2005

(54) Removable cover for a glucose meter

(76) Inventors: Andreas Moller, Munchen (DE); Julian Schlagheck, Munchen (DE); Claus Steinberg, Munchen (DE); Christoph Dunwald, Leverkusen (DE)

Correspondence Address: Alice A. Brewer, Esq.;Bayer HealthCare LLC, P. O. Box 40, Elkhart, IN, 46515-0040, US

(21) Appl. No.: 10/978,888

(22) Filed: Nov. 1, 2004

Related U.S. Application Data
(63) Continuation of application No. 09/915,998, filed on Jul. 26, 2001, now abandoned.

(51) Int. Cl. B32B 5/02

(52) U.S. Cl. 422/104

(57) ABSTRACT

An apparatus for covering a glucose meter is described, wherein the glucose meter has a front surface opposed to a back surface, and an edge surface connecting the front surface to the back surface. The apparatus comprises a frame adapted to receive the glucose meter and at least one attachment member connected with the frame. The frame is adapted to surround a substantial portion of the edge surface and form an opening for viewing at least a portion of the front surface of the glucose meter. The attachment member is adapted to removably connect the frame with the glucose meter.

This is a continuation of prior application Ser. No. 09/915,998, filed Jul. 26, 2001, now pending.

### FIELD OF THE INVENTION

The present invention relates to a cover for a glucose meter. More particularly, the present invention relates to a cover that can be removably connected with a glucose meter.

### BACKGROUND

Blood glucose meters are used to measure the level of glucose in a user's blood. Generally, to operate a blood glucose meter, a user deposits a drop of blood onto a disposable cartridge or pad. The disposable cartridge along with the drop of blood is then inserted into a slot located on the blood glucose meter whereupon the blood glucose meter tests the blood located on the disposable cartridge in order to determine the level of glucose in the blood. Often times, upon determining the level of glucose in the blood, the blood glucose meter displays this information along with other information on a screen located on the blood glucose meter.

Often times, blood glucose meters are self-contained units having a case or housing manufactured from a rigid material such as plastic. Plastic is prone to becoming scratched and may become cracked or even broken if the blood glucose meter suffers an impact, such as being dropped onto a floor. Additionally, some blood glucose meters houses a screen for displaying information. A screen for displaying information may be very fragile and therefore easily damaged if the blood glucose meter or the screen itself suffers an impact. Moreover, often times the surface of a blood glucose meter may be relatively smooth and lack any features or means for allowing a user to effectively grip the blood glucose meter. If the user is unable to effectively grip the blood glucose meter, the user may lose contact with the blood glucose meter and the blood glucose meter may suffer an impact and become damaged.

Sometimes, blood glucose meters are manufactured using a bland, typically non-descriptive, color. A bland color does not stand out and does not allow the user to easily locate the blood glucose meter if the blood glucose meter is ever lost. Additionally, some blood glucose meters have little or no information located on their surface. If the blood glucose meter has little or no information located on its surface, the blood glucose meter may lack valuable information such as the user's name, instructions on how to use the blood glucose meter, or even a design or pattern which can be used to identify the blood glucose meter.

Accordingly, there is a need for a device that can provide additional gripping means for a user to grip onto the blood glucose meter, which can protect the blood glucose meter from becoming damaged when the blood glucose meter suffers an impact, and which can provide valuable information such as a user's name, instruction's on how to use the blood glucose meter, or a design or pattern which can be used to identify the blood glucose meter.

### SUMMARY

According to a first aspect of the present invention, an apparatus for covering a glucose meter is provided. The glucose meter has a front surface opposed to a back surface, and an edge surface connecting the front surface to the back surface. The apparatus comprises a frame adapted to receive the glucose meter and at least one attachment member connected with the frame. The frame is adapted to surround a substantial portion of the edge surface and form an opening for viewing at least a portion of the front surface of the glucose meter. The attachment member is adapted to removably connect the frame with the glucose meter.

According to another aspect of the present invention, an apparatus for covering a glucose meter is provided. The glucose meter has a front surface opposed to a back surface, and an edge surface connecting the front surface to the back surface, wherein the front surface includes a screen for viewing information. The apparatus comprises a frame adapted to receive the glucose meter and at least one attachment member connected with the frame. The frame is adapted to cover a substantial portion of the front surface and a small portion of the back surface of the glucose meter. The attachment member is adapted to removably connect the frame with the glucose meter.

According to another aspect of the present invention, a glucose meter is provided. The glucose meter has a front surface opposed to a back surface, and an edge surface connecting the front surface to the back surface. The glucose meter comprises a screen located on the front surface for viewing information, and a cover removably connected with the glucose meter. The cover includes a frame adapted to receive the glucose meter and at least one attachment member connected with the frame. The frame is adapted to surround a portion of the edge surface of the glucose meter. The attachment member is adapted to removably connect the frame with the glucose meter, wherein the attachment member contacts a small portion of the back surface.

### BRIEF DESCRIPTION OF THE DRAWINGS

FIG. 1 is a perspective view of a removable cover attached to a glucose meter, in accordance with one embodiment;

FIG. 2 is an exploded perspective view of a removable cover and a glucose meter, in accordance with one embodiment;

FIG. 3 is a front view of a removable cover attached to a glucose meter, in accordance with one embodiment;

FIG. 4 is a rear view of the removable cover of FIG. 3, in accordance with one embodiment;

FIG. 5 is a cross-sectional side view of the removable cover attached to the glucose meter of FIG. 3, in accordance with one embodiment;

FIG. 6 is a perspective view of a removable cover attached to a glucose meter, in accordance with one embodiment; and

FIG. 7 is an exploded perspective view of a removable cover and a glucose meter, in accordance with one embodiment.

For simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF THE PRESENTLY PREFERRED EMBODIMENTS

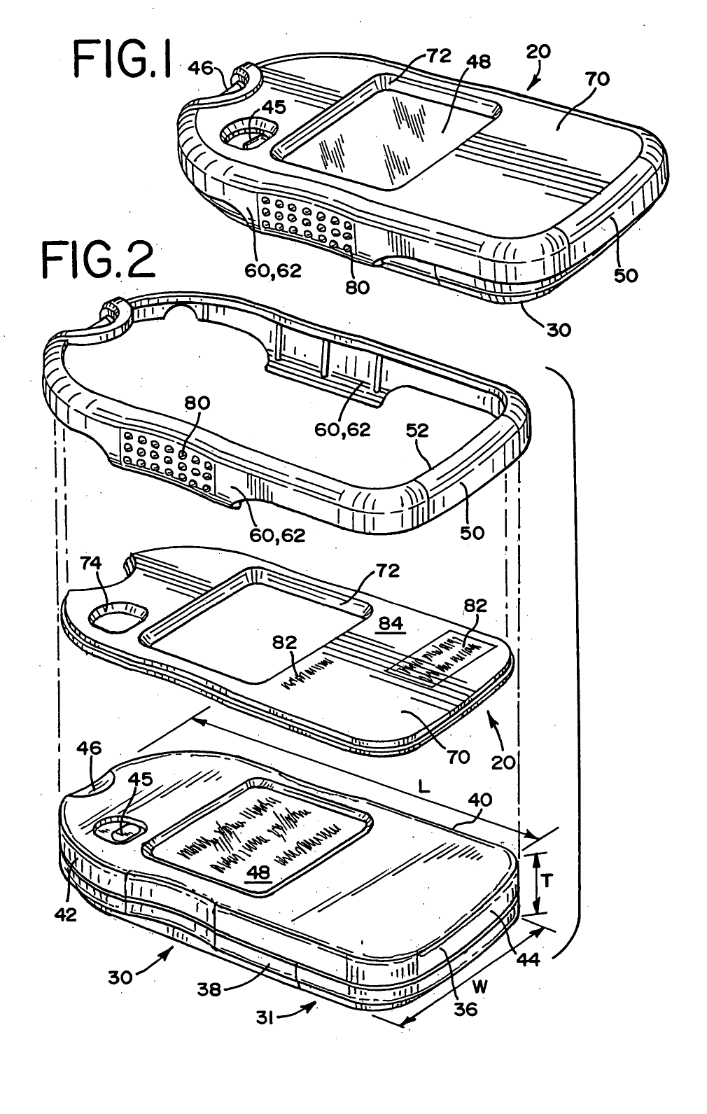

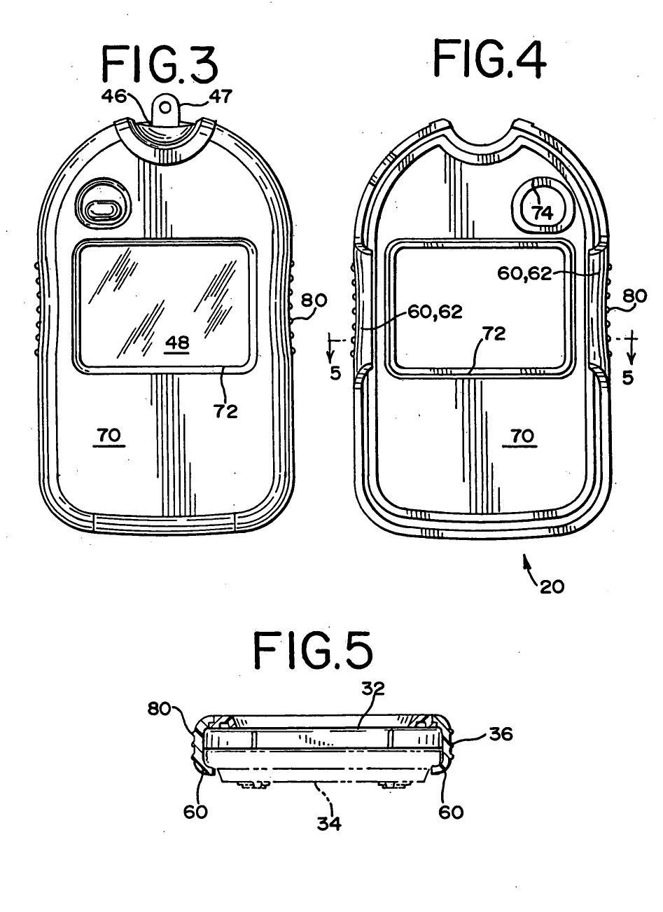

FIGS. 1-5 illustrate one embodiment of a cover 20 for covering a glucose meter 30. Glucose meter 30 can be any device that can be used to determine the level of glucose in a user's blood. Preferably, glucose meter 30 is a portable blood glucose meter that can be carried along with a user, such as the GLUCOMETER ELITE XL™, blood glucose meter available from BAYER CORPORATION™ of Territown, N.Y., United States of America. A portable blood glucose meter has to be light enough so that a user may carry it around. Preferably, a portable blood glucose meter weighs less than 2000 grams, and more preferably, less than 500 grams. A portable blood glucose meter must also have dimensions that are small enough to allow a user to carry it around. Preferably, a portable blood glucose meter has a width W of less than 10 centimeters, a length L of less than 20 centimeters, and a thickness T of less than 5 centimeters, as illustrated in FIG. 2. More preferably, a portable blood glucose meter has a width W of less than 7 centimeters, a length L of less than 12 centimeters, and a thickness T of less than 3 centimeters.

Glucose meter 30 has a front surface 32 opposed to a back surface 34, and an edge surface 36 connecting the front surface 32 to the back surface 34, as illustrated in FIGS. 2 and 5. The front surface 32 includes a screen 48 for viewing information, such as the user's blood glucose level. Screen 48 includes any device that can display information such as, but not limited to, a cathode ray tube, an LCD screen, or any other means for allowing a user to view information. Preferably, screen 48 comprises an LCD screen, since an LCD screen is lightweight, thin, and typically compact enough so that a user can easily carry glucose meter 30 around. Preferably front surface 32 also includes a power button 45 for turning the glucose meter 30 on. However, the power button 45 may be located on alternate surfaces of glucose meter 30, such as the back surface 34 or the edge surface 36.

The front surface 32, the back surface 34 and the edge surface 36 form a housing 31 for the glucose meter 30. Preferably, the housing 31 comprises a rigid material, such as, but not limited to: metals such as iron, steel, aluminum, titanium, and brass; plastics such as ethylene-vinyl acetate; acrylics such as acrylonitrile-butadiene-styrene and acrylic-styrene-acrylonitrile; polymers such as polycarbonate, polyurethane, polythylene, polybutylene, polyvinyl chloride, polyphenylene oxide, chlorinated polyvinyl chloride, polyamides, and polybutylene terephthalate; carbon fiber; graphite; and any other rigid material known to those skilled in the art. The housing 31 may be formed in one of many ways known to those skilled in the art, such as die-casting, machine forming, traditional molding, and blow-molding. The housing 31 acts as a means for storing any electronics located within the glucose meter 30 and acts as a means for mounting items such as the screen 48 and the power button 45.

The cover 20 may be colored any color known to those skilled in the art. Preferably, the cover 20 is not colored in a bland color, but rather a distinct color that stands out and allows the user to more easily locate the glucose meter 30 if the glucose meter 30 is ever lost. A distinct color includes such colors as fluorescent colors, metallic colors, bright colors such as yellow, red, orange, intermediate colors such as blue or green, and even solid black or solid white. The cover 20 includes a frame 50 and at least one attachment member 60 connected with the frame 50.

The frame 50 is adapted to receive the glucose meter 30. Preferably, the frame 50 comprises a rigid material, such as, but not limited to: metals such as iron, steel, aluminum, titanium, and brass; plastics such as ethylene-vinyl acetate; acrylics such as acrylonitrile-butadiene-styrene and acrylic-styrene-acrylonitrile; polymers such as polycarbonate, polyurethane, polythylene, polybutylene, polyvinyl chloride, polyphenylene oxide, chlorinated polyvinyl chloride, polyamides, and polybutylene terephthalate; carbon fiber; graphite; and any other rigid material known to those skilled in the art. In one embodiment, the frame 50 is adapted to surround a substantial portion of the edge surface 36. As used herein, a substantial portion of the edge surface 36 is a portion of the edge surface 36 that includes at least 75 percent of the perimeter of the edge surface 36. Preferably a substantial portion of the edge surface 36 is a portion that includes least 90 percent of the perimeter surrounding the edge surface 36, as illustrated in FIGS. 1 and 2. In one embodiment, the frame 50 forms an opening 52 for viewing at least a portion of the front surface 32 of the glucose meter 30, as illustrated in FIGS. 2 and 7. In one embodiment, opening 52 is designed to receive an interchangeable faceplate 70, as illustrated in FIGS. 1 and 2. In one embodiment, opening 52 forms a window 54 for viewing at least a portion of the screen 48, and preferably, for viewing the entire screen 48, as illustrated in FIG. 7.

In one embodiment, the frame 50 does not cover a substantial portion of the back surface 34 of the glucose meter 30. As defined herein, a substantial portion of the back surface 34 of the glucose meter 30 is a portion that includes at least 90 percent of the surface area of back surface 34, and more preferably, that includes at least 50 percent of the back surface 34 of glucose meter 30. In one embodiment, the frame 50 covers a small portion of the back surface 34 of the glucose meter 30. As defined herein, a small portion of the back surface 34 is a portion that includes no more than 20 percent of the service area of back surface 34. By not covering a substantial portion of the back surface 34 or by covering a small portion, the weight of cover 20 is substantially less than it could be, and therefore the combination of the glucose meter 30 and the cover 20 may be relatively light in weight. Moreover, when the frame 50 does not covering a substantial portion of the back surface 34 or covers only a small portion, the frame 50 may be more readily removed from the glucose meter 30. Moreover, a user may more easily switch from one cover 20 to a second cover 20 when the frame 50 does not covering a substantial portion of the back surface 34 or covers only a small portion.

In one embodiment, the frame 50 is adapted to cover a substantial portion of the front surface 32. As defined herein, a substantial portion of the front surface 32 is a portion of the front surface 32 that includes at least 50 percent of the surface area of the front surface 32.

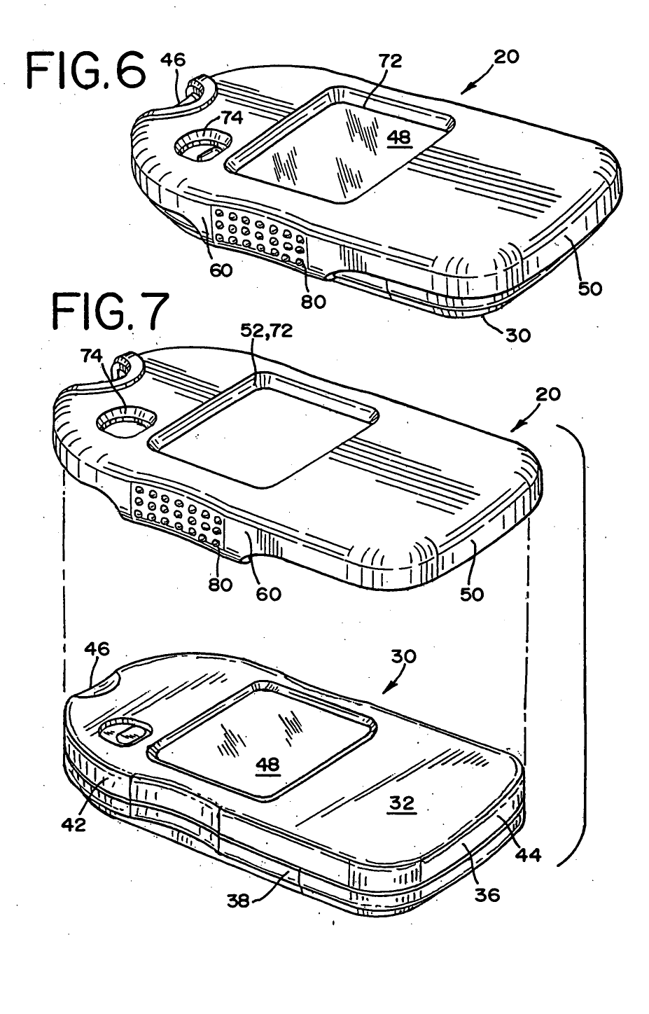

Cover 20 also includes at least one attachment member 60 connected with the frame 50, wherein the attachment member 60 is adapted to removably connect the frame 50 with the glucose meter 30, as illustrated in FIGS. 1 and 6. Attachment member 60 can be generally any type of coupling mechanism known to those skilled in the art, such as, an alligator clip, a clamp, a magnet, a hook and loop type fastener (such as a strip of VELCRO™), a snap fit arrangement or any other comparable coupling mechanism which can be removably coupled to an object, such as the glucose meter 30. In one embodiment, the attachment member 60 is a snap-fit clip 62 that is adapted to removably connect the frame 50 with the glucose meter 30, as illustrated in FIGS. 1 and 2. Attachment member 60 is connected with frame 50 in one of many ways known to those skilled in the art such as, for example, welding, gluing, stapling, snap fit arrangement, a hinge, a nut and bolt arrangement, a screw, or any other means known to those skilled in the art for connecting a first object with a second object. In one embodiment, attachment member 60 is integrally formed with frame 50, as illustrated in FIGS. 1 and 2. In one embodiment, cover 20 comprises a second attachment member 60 connected with the frame 50, wherein the second attachment member 60 is adapted to removably connect the frame 50 with a glucose meter 30, as illustrated in FIG. 2.

In one embodiment, cover 20 includes an interchangeable faceplate 70 which is removably connected with the frame 50 and received by the opening 52 in the frame 50, as illustrated in FIGS. 1 and 2. In this embodiment, opening 52 of frame 50 is adapted to receive the interchangeable faceplate 70, as illustrated in FIG. 2. The interchangeable faceplate 70 is removably connected with the frame 50 using any type of coupling mechanism known to those skilled in the art, such as, an alligator clip, a clamp, a magnet, a hook and loop type fastener (such as a strip of VELCRO™), a snap fit arrangement or any other comparable coupling mechanism which can be removably coupled to an object, such as the frame 50. While in the above described embodiments, interchangeable faceplate 70 is removably connected with frame 50, interchangeable faceplate 70 may be fixedly connected with frame 50 using any means known to those skilled in the art. In operation, interchangeable faceplate 70 is received by the opening 52 in the frame 50 and then connected with the frame 50. Attachment member 60 is then removably connected with the glucose meter 30, as illustrated in FIGS. 1 and 2. Preferably, the interchangeable faceplate 70 forms a window 72 for viewing the screen 48 located on the front surface 32 of the glucose meter 30.

Interchangeable faceplate 70 may also include information 82 located on the surface 84 of interchangeable faceplate 70. Information 82 includes any information known to those skilled in the art that may be imprinted, embossed, placed, or encoded on the surface 84. Preferably, information 82 includes useful information such as the user's name, instructions on how to use the glucose meter 30, or even a design or pattern which can be used to identify the glucose meter 30. In one embodiment, interchangeable faceplate 70 is integrally formed with frame 50, as illustrated in FIGS. 6 and 7.

In one embodiment, glucose meter 30 includes a slot 46 for receiving a disposable cartridge 47, wherein the frame 50 surrounds a portion of the slot 46, as illustrated in FIG. 1 and FIG. 2. In one embodiment, the slot 46 is located on the edge surface 36 of the glucose meter 30, as illustrated in FIGS. 1 and 2. By not covering slot 46, frame 50 of cover 20 allows a user to insert the disposable cartridge 47 into the slot 46 when the frame 50 is connected with the glucose meter 30. In this way, the user may obtain a measurement for the user's blood glucose level using glucose meter 30 without having to remove frame 50.

In one embodiment, edge surface 36 comprises a first side surface 38 opposed to a second side surface 40, and a top surface 42 opposed to a bottom surface 44, as illustrated in FIG. 2 and FIG. 5. In this embodiment, the frame 50 contacts at least a portion of the first side surface 38, the second side surface 40, the top surface 42, and the bottom surface 44. In one embodiment, the frame 50 contacts the edge surface 36 in at least two places, and more preferably in at least three places.

In one embodiment, cover 20 includes a gripping member 80 connected with the frame 50. Gripping member 80 is any type of device known to those skilled in the art that can be used to aid a user in gripping an object, such as, a bump, a ridge, a rubber bump, a rubber ridge, a rubber member, a surface covered with adhering materials, and other such device. Preferably, gripping member 80 is integrally formed with the frame 50, as illustrated in FIGS. 1-4. When cover 20 is connected with glucose meter 30, gripping member 80 helps the user maintain and grip the glucose meter 30.

In one embodiment, a method for distributing disposable cartridges 47 for a glucose meter 30 is described, wherein the method comprises packaging at least one cover 20, as described above, with at least one disposable cartridge 47. By packaging a cover 20 with a disposable cartridge 47, as user is able more easily obtain accessories, such as a cover 20 and a disposable cartridge 47, for a glucose meter 30.

Thus, there has been disclosed in accordance with the invention, an apparatus for covering a glucose meter that fully provides the advantages set forth above. Although the invention has been described and illustrated with reference to specific illustrative embodiments thereof, it is not intended that the invention be specific limited to those illustrative embodiments. Those skilled in the art will recognize that variations and modifications can be made without departing from the spirit of the invention. It is therefore intended to include within the invention all such variations and modifications that fall within the scope of the appended claims and equivalents thereof.

1. An apparatus for covering a glucose meter, wherein the glucose meter has a front surface opposed to a back surface, and an edge surface connecting the front surface to the back surface, the apparatus comprising:
a frame adapted to receive the glucose meter, wherein the frame is adapted to surround a substantial portion of the edge surface, and wherein the frame forms an opening for viewing at least a portion of the front surface of the glucose meter; and
at least one attachment member connected with the frame, wherein the attachment member is adapted to removably connect the frame with the glucose meter.

2. The apparatus of claim 1, further comprising an interchangeable faceplate removably connected with the frame and received by the opening in the frame.

3. The apparatus of claim 2, wherein the interchangeable faceplate forms a window for viewing a screen located on the front surface.

4. The apparatus of claim 1, wherein the glucose meter includes a slot for receiving a disposable cartridge located on the edge surface, and wherein the frame surrounds the slot.

5. The apparatus of claim 1, wherein the frame does not cover a substantial portion of the back surface.

6. The apparatus of claim 1, wherein the frame contacts only a small portion of the back surface in order to allow the frame to be more readily removed from the glucose meter.

7. The apparatus of claim 1, wherein the edge surface comprises a first side surface opposed to a second side surface, and a top surface opposed to a bottom surface, and wherein the frame contacts at least a portion of the first side surface, the second side surface, the top surface, and the bottom surface.

8. An apparatus for covering a glucose meter, wherein the glucose meter has a front surface opposed to a back surface, and an edge surface connecting the front surface to the back surface, wherein the front surface includes a screen for viewing information, the apparatus comprising:
a frame adapted to receive the glucose meter, wherein the frame is adapted to cover a substantial portion of the front surface and a small portion of the back surface; and
at least one attachment member connected with the frame, wherein the attachment member is adapted to removably connect the frame with the glucose meter.

9. The apparatus of claim 8, wherein the frame forms a window for viewing a screen located on the front surface.

10. The apparatus of claim 8 further comprising a gripping member connected with the frame.

11. The apparatus of claim. 10, wherein the gripping member is integrally formed with the frame.

12. The apparatus of claim 8, wherein the attachment member is integrally formed with the frame.

13. The apparatus of claim 8 further comprising a second attachment member connected with the frame, wherein the second attachment member is adapted to removably connect the frame with the glucose meter.

14. The apparatus of claim 8, wherein the edge surface comprises a first side surface opposed to a second side surface, and a top surface opposed to a bottom surface, and wherein the frame contacts at least a portion of the first side surface, the second side surface, the top surface, and the bottom surface.

15. A glucose meter, wherein the glucose meter has a front surface opposed to a back surface, and an edge surface connecting the front surface to the back surface, the glucose meter comprising:
a screen located on the front surface for viewing information; and
a cover removably connected with the glucose meter, the cover including a frame adapted to receive the glucose meter, wherein the frame is adapted to surround a portion of the edge surface, and at least one attachment member connected with the frame, wherein the attachment member is adapted to removably connect the frame with the glucose meter, and wherein the attachment member contacts a small portion of the back surface.

16. The glucose meter of claim 15, wherein the frame forms a window for viewing a screen located on the front surface.

17. The glucose meter of claim 15, wherein the edge surface comprises a first side surface opposed to a second side surface, and a top surface opposed to a bottom surface, and wherein the frame contacts at least a portion of the first side surface, the second side surface, the top surface, and the bottom surface.

18. The glucose meter of claim 15, further comprising an interchangeable faceplate removably connected with the frame and received by an opening in the frame.

19. The apparatus of claim 15, wherein the interchangeable faceplate forms a window for viewing a screen located on the front surface.

20. The apparatus of claim 15, wherein the interchangeable faceplate includes a stylized design on a portion of the faceplate.

21. The apparatus of claim 15, wherein the frame does not cover a substantial portion of the back surface.

22. A method for distributing disposable cartridges for a glucose meter, the method comprising packaging the apparatus of claim 1 with at least one disposable cartridge.
